(19) United States
(12) Patent Application Publication
(10) Pub. No.: US 2018/0004389 A1
(43) Pub. Date: Jan. 4, 2018

(54) DISPLAY INPUT DEVICE AND IMAGE FORMING APPARATUS

(71) Applicant: KYOCERA Document Solutions Inc., Osaka (JP)

(72) Inventors: Takanori MIYAMOTO, Osaka (JP); Naoto HANADA, Osaka (JP); Norie FUJIMOTO, Osaka (JP); Takushi DANDOKO, Osaka (JP)

(73) Assignee: KYOCERA Document Solutions Inc., Osaka (JP)

(21) Appl. No.: 15/628,078

(22) Filed: Jun. 20, 2017

(30) Foreign Application Priority Data
Jun. 29, 2016 (JP) 2016-129432

(51) Int. Cl. G06F 3/0488; G06F 3/12; G06F 3/0481

(52) U.S. Cl. CPC G06F 3/0488; G06F 3/04817; G06F 3/1207

(57) ABSTRACT

A display input device includes: a display section capable of displaying characters and images; a touch panel disposed on the display section and accepting input by pressing on a soft button displayed on a display screen of the display section; and a control unit including a processor and performing, when the processor operates in accordance with an operation program, a display control of the display screen and a control for instructing the display section to display a message. When instructing the display of the message while allowing the display section to display the display screen, the control unit provides a pop-up display of the message at a pop-up display position of the display screen set at a location other than a predetermined display region of the display screen. The touch panel accepts the input by pressing on the soft button even while the control unit provides the pop-up display.

### INCORPORATION BY REFERENCE

This application claims priority to Japanese Patent Application No. 2016-129432 filed on 29 Jun. 2016, the entire contents of which are incorporated by reference herein.

### BACKGROUND

The present disclosure relates to a display input device that displays an operation screen, a message or others for a user and accepts an operation instruction, and an image forming apparatus including the display input device.

A display input device provided on an image forming apparatus generally has a touch panel function and displays an operating status of the apparatus, soft buttons for accepting operation instructions from a user, various messages, and so on.

Conventionally, the display position for various messages within the display area on the display input device is previously determined and always secured. However, recent image forming apparatuses have had an increasing number of functions and often perform a plurality of tasks at the same time, so that the contents displayed on the display input device have been complicated and a large amount of information has been displayed thereon. In this situation, the existence of the fixed region for displaying messages in the display area on the display input device hinders effective use of the display area.

There is known a technique in which a message is displayed in a banner in a conventional display input device. There is also known a technique in which when a main apparatus during a locked state undergoes a status change, such as receipt of a mail, a conventional display input device displays a notification icon on its locked screen. There is also known, as for a conventional display input device, a technique for providing a pop-up display on a display section of an image forming apparatus.

### SUMMARY

A technique improved over the aforementioned techniques is proposed as one aspect of the present disclosure.

A display input device according to an aspect of the present disclosure includes a display section, a touch panel, and a control unit. The display section is capable of displaying characters and images. The touch panel is disposed on the display section and accepts input by pressing on a soft button displayed on a display screen of the display section. The control unit includes a processor and performs, when the processor operates in accordance with an operation program, a display control of the display screen to be displayed on the display section and a control for instructing the display section to display a message. Furthermore, when instructing the display section to display the message while allowing the display section to display the display screen, the control unit provides display of the message in the form of a pop-up at a pop-up display position of the display screen set at a location other than a predetermined display region of the display screen. The touch panel accepts the input by pressing on the soft button even while the control unit provides the display of the pop-up.

An image forming apparatus according to another aspect of the present disclosure includes the above display input device and an image forming section that forms an image on a recording medium.

### BRIEF DESCRIPTION OF THE DRAWINGS

FIG. 1 is a schematic view showing an image forming apparatus.

FIG. 2 is a functional block diagram showing an essential internal configuration of the image forming apparatus.

FIG. 3 is a table showing exemplary contents stored in a pop-up display manner storage section.

FIG. 4 is a flowchart showing pop-up display processing in the image forming apparatus.

FIG. 5A is a view showing an example of a display screen.

FIG. 5B is a view showing another example of the display screen.

FIG. 5C is a view showing still another example of the display screen.

FIG. 6 is a view showing still another example of the display screen.

FIG. 7 is a view showing still another example of the display screen.

FIG. 8 is a view showing still another example of the display screen.

FIG. 9 is a view showing still another example of the display screen.

FIG. 10 is a view showing still another example of the display screen.

FIG. 11 is a view showing still another example of the display screen.

FIG. 12 is a view showing still another example of the display screen.

FIG. 13 is a view showing an example of a display screen.

### DETAILED DESCRIPTION

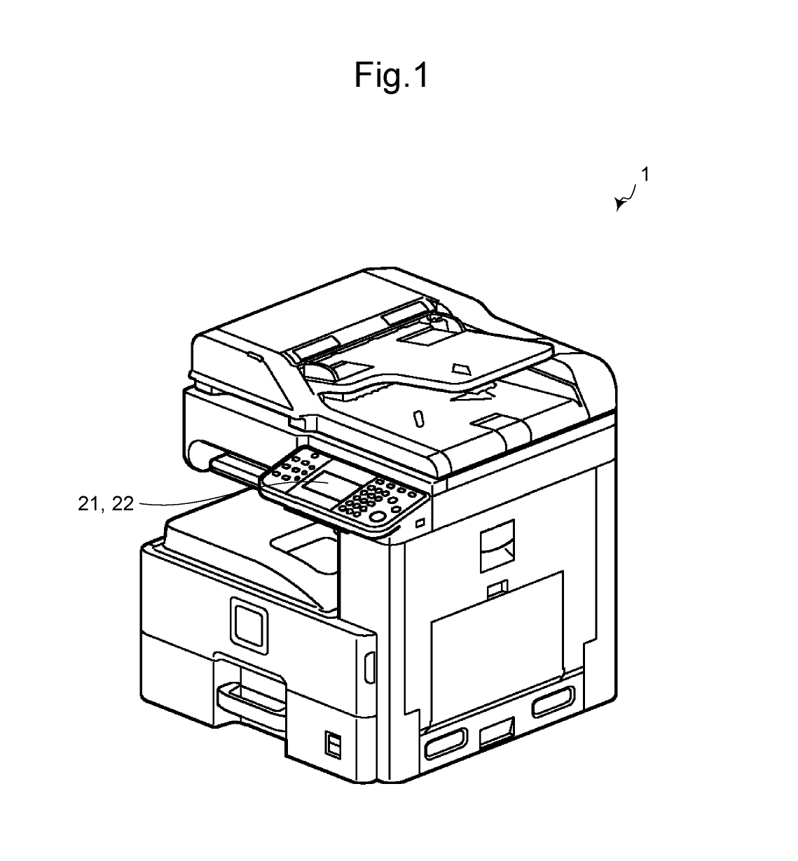

Hereinafter, a description will be given of a display input device and an image forming apparatus, both according to one embodiment of the present disclosure, with reference to the drawings. FIG. 1 is a schematic view showing an image forming apparatus 1 according to the present disclosure.

In FIG. 1, the image forming apparatus 1 is constituted by, for example, an electrophotographic image forming apparatus in which toner is used as a developer, or an inkjet printer in which ink is used, and the image forming apparatus 1 is provided at the front of a main body thereof with a display section 21 and a touch panel 22 which are integrally formed.

The display section 21 is a display formed of an LCD (Liquid Crystal Display) or the like and displays operation procedures, various messages, operating buttons (soft buttons), and so on. The display section 21 and the touch panel 22 are integrally formed. The touch panel 22 is, for example, a resistive film touch panel and has the function of detecting a position (coordinate) of a user's touch on the touch panel 22 and outputting the detected position information to a control unit 11 described below. The control unit 11 specifies the position of touch based on the position information output from the touch panel 22 and performs processing associated with the position of touch.

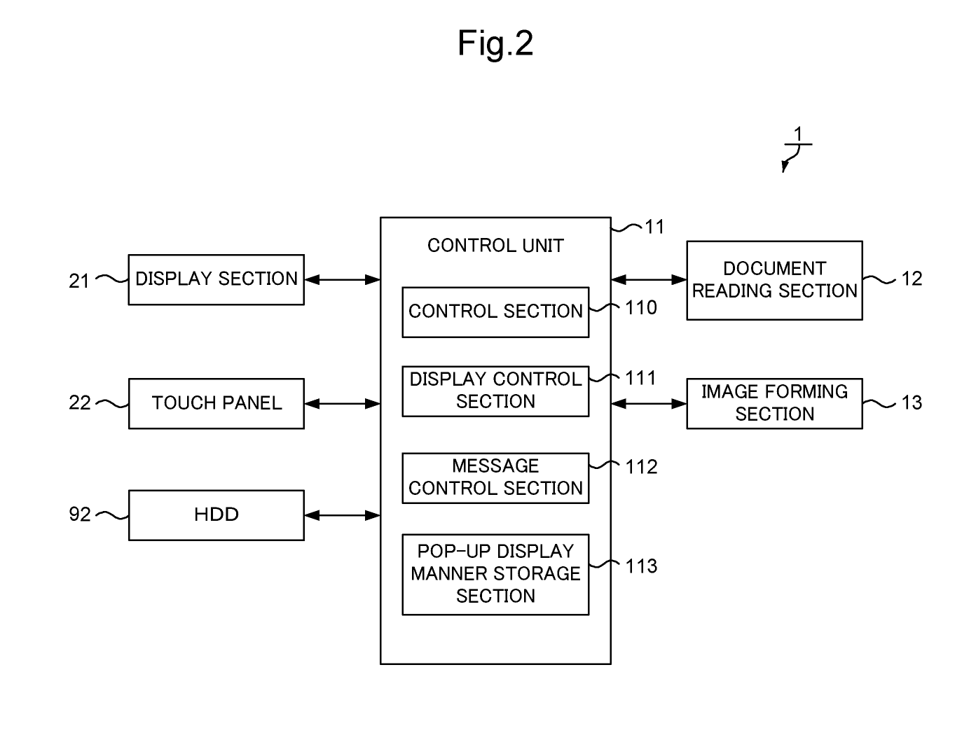

FIG. 2 is a functional block diagram showing an essential internal configuration of the image forming apparatus 1. The image forming apparatus is made up of the control unit 11, the display section 21, the touch panel 22, a document reading section 12, an HDD 92, an image forming section 13, and so on.

The document reading section 12 reads an image of an original document to acquire image data. The image forming section 13 prints, on a sheet, an image based on the image data acquired by the document reading section 12 or image data sent from an external device.

The control unit 11 is made up of a processor, a RAM, a ROM, a dedicated hardware circuit, and so on. The processor is, for example, a CPU (Central Processing Unit), an MPU or an ASIC. The control unit 11 includes a control section 110, a display control section 111, a message control section 112, and a pop-up display manner storage section 113.

The control unit 11 functions as the display control section 111, the message control section 112, and the pop-up display manner storage section 113 by operation of the processor in accordance with a control program installed on the HDD 92. Alternatively, each of the above sections may not be implemented by the operation of the control unit 11 in accordance with the control program but may be constituted by a hardware circuit. Hereinafter, the same applies to the other embodiments unless otherwise stated.

The control section 110 governs the overall operation control of the image forming apparatus 1.

The display control section 111 performs the display control of the display section 21. Specifically, when the message control section 112 issues an instruction to display a message, the display control section 111 retrieves from the pop-up display manner storage section 113 a specific display manner of displaying the message, the display manner being associated with a level of importance added to the message. Then, based on the retrieved display manner, the display control section 111 allows the display section 21 to display the message in the form of a pop-up.

The message control section 112 issues, on the occurrence of a matter of notification to the user about the operation of the image forming apparatus 1, an instruction to the display control section 111 to display the contents of a message corresponding to the matter of notification and represent the level of importance of the message.

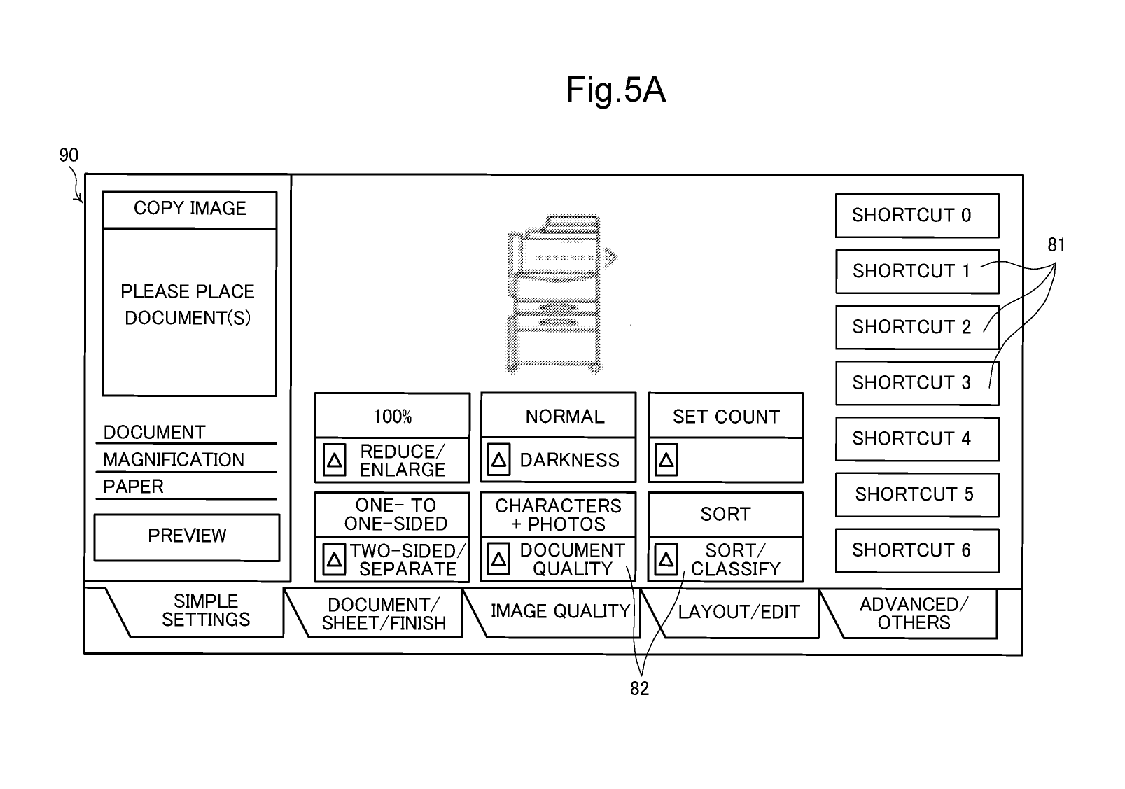

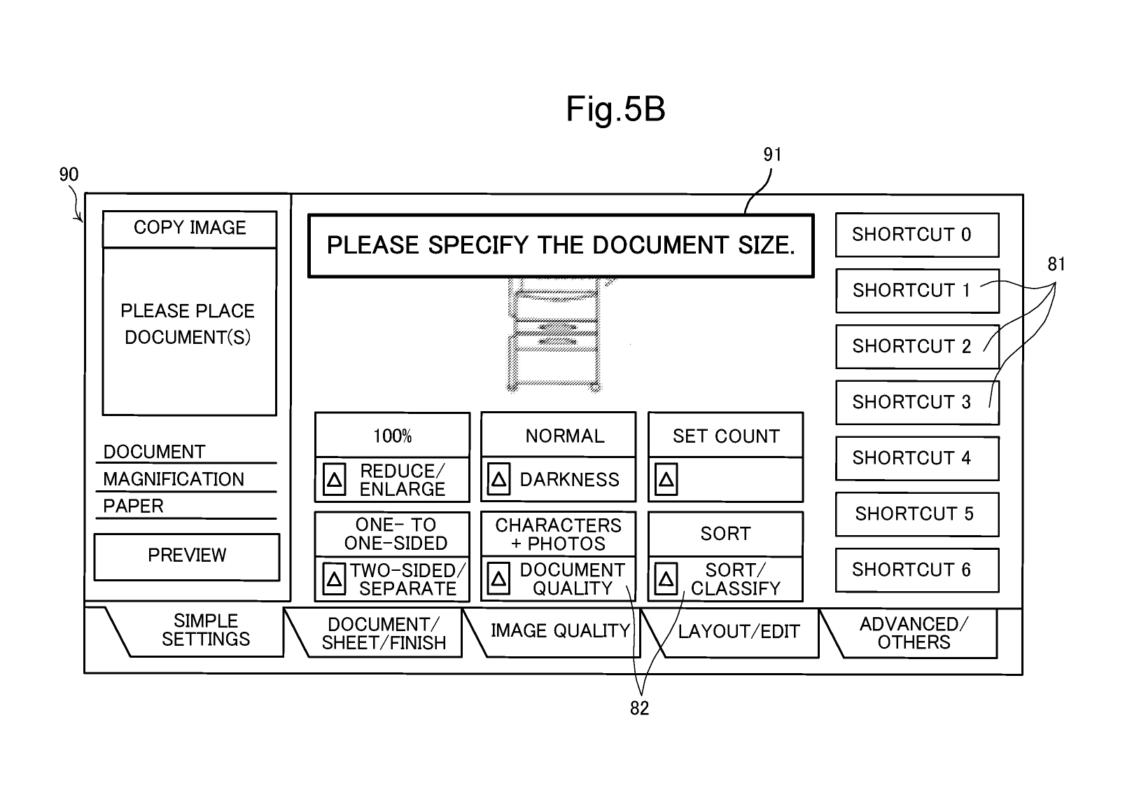

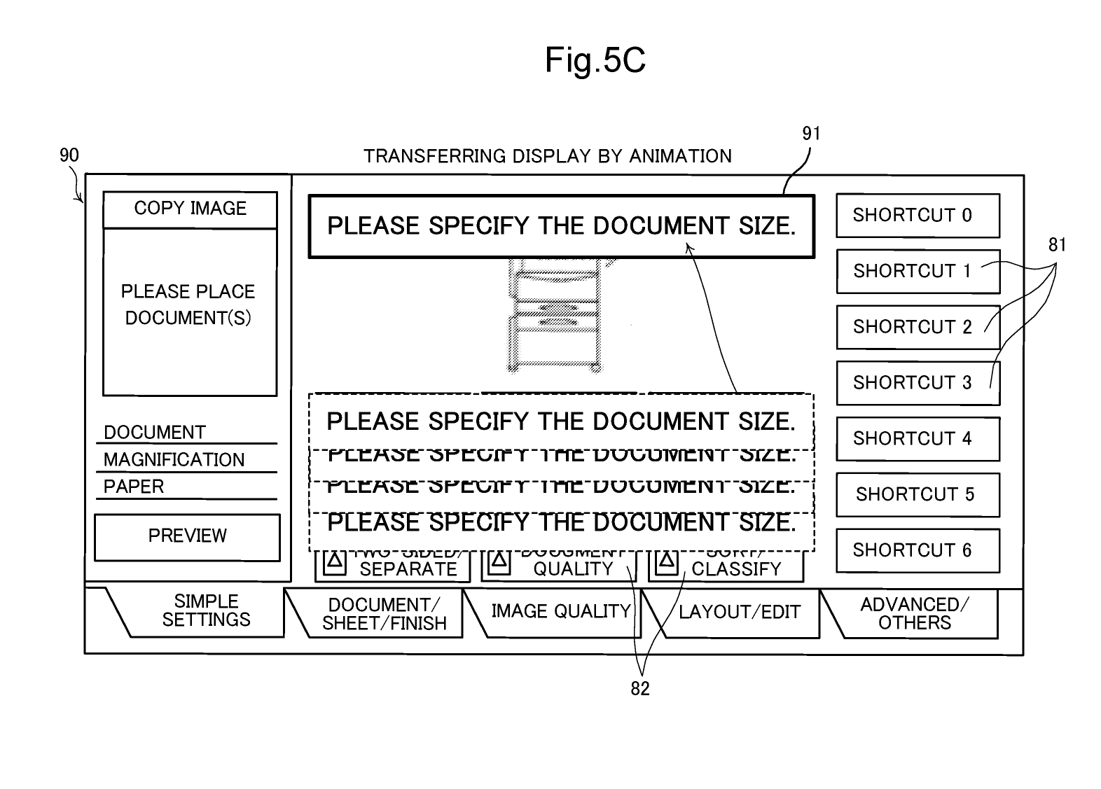

For example, in the case where during a copy mode of the image forming apparatus 1 the user places an original document in the document reading section 12 and presses a start button for instructing the start of a copy operation, but the size of the placed original document is an automatically undetectable, indefinite size and cannot be specified, the message control section 112 issues an instruction to the display control section 111 to display a massage of “PLEASE SPECIFY THE DOCUMENT SIZE” and represent the level of importance of this message. Then, the display control section 111 allows the display section 21 to display, for example, a pop-up 91 as shown in FIG. 5B.

In this regard, the “level of importance” is indicated by, for example, a numerical value so that the higher “level of importance” is indicated by a larger value. The “level of importance” is previously determined depending on the operation mode of the image forming apparatus 1 at the moment and the contents of the matter of notification. For example, in the case where when the image forming apparatus 1 is in a copy, scan or facsimile mode, an original document of indefinite size is placed in the document reading section 12 and an instruction to start a copy operation is issued, the document reading section 12 cannot perform scanning until the document size is specified, and thus the image forming section 13 cannot start printing. Therefore, a high level of importance is assigned to the message of “PLEASE SPECIFY THE DOCUMENT SIZE”. The message control section 112 outputs to the display control section 111 an instruction to display the message of “PLEASE SPECIFY THE DOCUMENT SIZE” and a value indicating the high level of importance of this message.

Unlike the above, in the case where when the image forming apparatus 1 is in a scan or facsimile mode, there is no sheet in cassettes for containing printing sheets, the image forming apparatus 1 can perform the processing even if there is no sheet in the cassettes. Therefore, a low level of importance is assigned to a message of “PLEASE LOAD SHEETS INTO CASSETTE”. The message control section 112 outputs to the display control section 111 an instruction to display the message of “PLEASE LOAD SHEETS INTO CASSETTE” and a value indicating the low level of importance of this message.

Furthermore, for example, when during suspension of operation of the image forming apparatus 1 for any reason an operation corresponding to one of predetermined forbidden conditions, such as pressing of a start button or the like, is performed, a message of which the user is to be notified is assigned a high level of importance.

The pop-up display manner storage section 113 stores a display manner of displaying a pop-up message and a level of importance of the message in association with each other. The display manner of displaying a pop-up stored in the pop-up display manner storage section 113 is previously factory-configured so that the higher the level of importance is, the more visible to the user the display manner is. For example, an administrator of the image forming apparatus 1 may operate the operating section (not illustrated) to select an arbitrary display manner for each level of importance and allow the pop-up display manner storage section 113 to store the selected display manner.

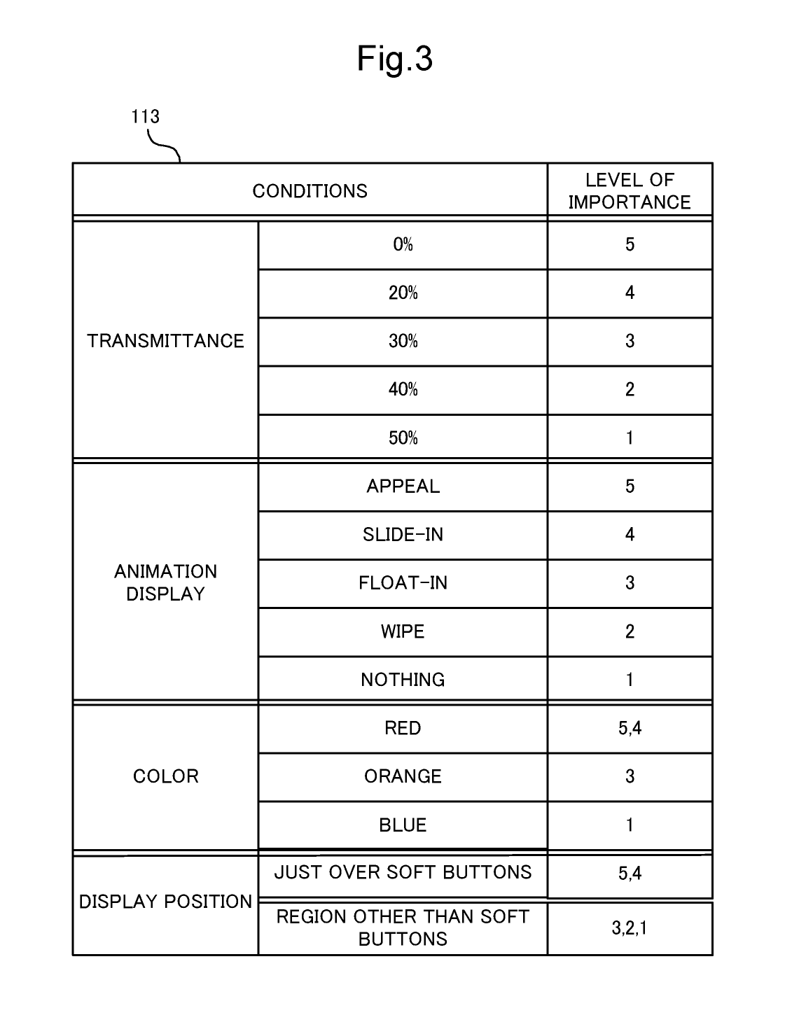

FIG. 3 is a table showing exemplary contents stored in the pop-up display manner storage section 113. The pop-up display manner storage section 113 stores the transmittance of the background color, animation display, color, display position, and so on of the pop-up by level of importance. For example, the transmittance is set so that the higher the level of importance of the message is, the lower the transmittance is, while the lower the level of importance is, the higher the transmittance is.

The animation display refers to displaying the pop-up, first at a predetermined position and then while transferring it to another predetermined position. Thus, the display is given movement, which makes the user more easily recognize that the pop-up is displayed. The animation display is set so that the higher the level of importance of the message is, the more effective the display manner is.

The color is the color for the pop-up, which may be the color of characters or the background color. It is desirable that the color is more distinguishable from the display screen of the display section 21 as the level of importance of the message is higher.

The display position refers to a pop-up display position where the pop-up is to be displayed (in the case of animation display, a position after the pop-up is transferred). Basically, it is desirable that the pop-up is displayed in a region other than the soft buttons so that the display of the pop-up may not hinder the user's visibility and operability of the screen. Specifically, for example, a region of the display screen of the display section 21 where a predetermined important message (such as soft buttons) has already been displayed is designated as a predetermined display region and the pop-up display position is set within a region of the display screen other than the predetermined display region.

When the level of importance of the message to be displayed in the form of a pop-up is extremely high, the pop-up display position is set in the predetermined display region. The reason for this is that, by displaying a pop-up message just over the predetermined display region instead, the pop-up can surely be recognized by the user. Furthermore, when the level of importance of the message is middle, the pop-up display position may be set such that the pop-up is displayed close to the soft buttons or partly overlapped with the soft buttons. As thus far described, since the level of importance is indicated by a numerical value and has a larger value as it is higher, the level of importance of each message can be easily graded and a pop-up display of the message for the user can be suitably implemented according to the graded level of importance.

As described previously, the contents stored in the pop-up display manner storage section 113 can be changed by the administrator or the like of the image forming apparatus 1. For example, when the image forming apparatus 1 is placed in an environment where it is used by male and female people in a wide age range, such as a convenience store or a public facility, the user is often unfamiliar with using the image forming apparatus 1 and may miss a pop-up displayed on the display section 21. Furthermore, it can be considered that even if the level of importance of the contents of the pop-up is not very high, a user's immediate recognition of the pop-up may facilitate the subsequent work.

When in such a situation the administrator selects a display manner that makes the user easily recognize the pop-up message even if the level of importance of the message is middle, the contents of the message can be surely delivered to the user even if the message contains not very important matter of notification.

In contrast, when the image forming apparatus 1 is placed in an office or the like and the user is familiar with using the image forming apparatus 1, it can be considered that even if, at the time when a message having a middle level of importance is displayed, any measure for the message is not immediately taken, the user may be able to deal adequately with the message even by measures taken after the end of the job. Therefore, it is sufficient that, for a pop-up display of a message having a high level of importance, a display manner that makes the user easily recognize the message is selected and, for a pop-up display having a middle or low level of importance, a display manner enough to keep from hindering job execution and user's gestures is selected.

The display manner of displaying a pop-up message can be suitably selected in the above manner according to the location of the image forming apparatus 1 (the user's degree of familiarity) or the level of importance of the message, thus providing a more effective display of the pop-up.

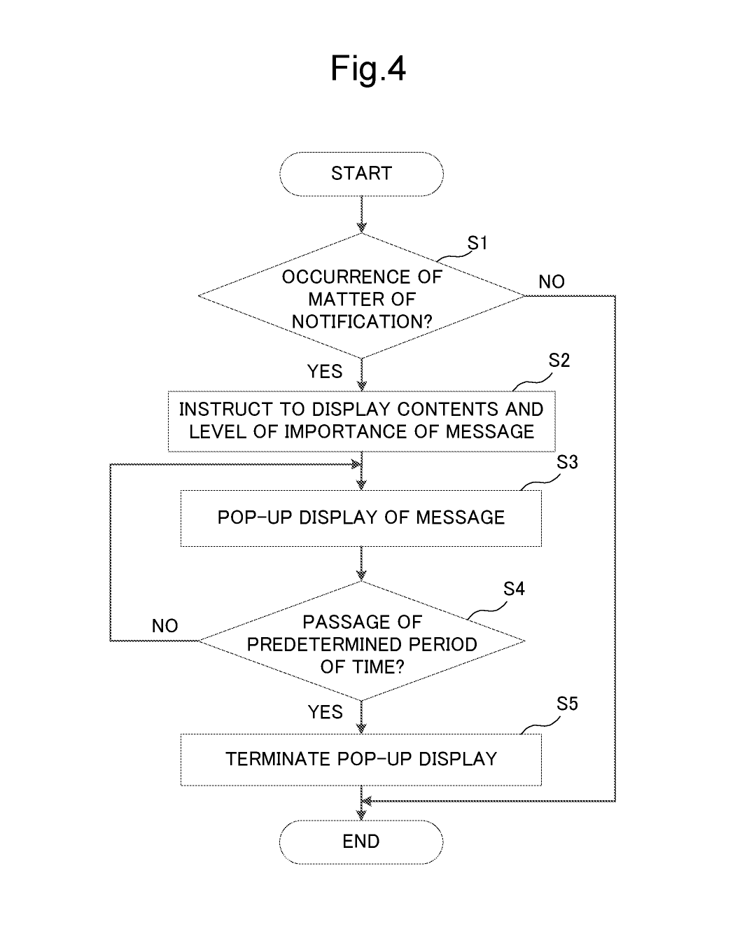

Next, a description will be given of pop-up display processing in the image forming apparatus 1. FIG. 4 is a flowchart showing the pop-up display processing in the image forming apparatus 1. FIGS. 5A to 13 are views showing examples of a display screen 90 which the display control section 111 allows the display section 21 to display.

In a general image forming apparatus, a fixed region of the display screen where a message newly required to be displayed is to be displayed is previously secured. In other words, the fixed region is a region where a message is displayed only when needed to be displayed, but nothing is displayed when there is no need to display anything.

However, in the image forming apparatus 1 according to this embodiment, such a fixed region is not provided in the display screen of the display section 21 as shown in FIG. 5A. In the image forming apparatus 1, such a fixed region is dispensed with and the entire display screen displayable in the display area of the display section 21 is put into a state where some information can be displayed thereon, so that the entire region of the display screen can be effectively used.

When a matter of notification to the user occurs during operation of the image forming apparatus 1 according to this embodiment (YES in 51), the message control section 112 issues an instruction to the display control section 111 to display the contents of a message about the matter of notification and represent the level of importance of the message (S2). For example, the message control section 112 issues an instruction to the display control section 111 to display a message of “PLEASE SPECIFY THE DOCUMENT SIZE”. In response to this, the display control section 111 provides display of the message in the form of a pop-up at the predetermined pop-up display position on the display screen of the display section 21 only for a predetermined period of time (for example, 10 seconds) (NO in S3 and S4). FIGS. 5B to 8 are views showing exemplary pop-up displays. After the passage of the predetermined period of time (YES in S4), the display control section 111 terminates the display of the pop-up (S5) and returns the display screen to the state shown in FIG. 5A.

Even during display of the pop-up, the touch panel 22 detects user's touch gestures on the soft buttons 81, 82 and so on.

The above predetermined period of time that specifies the timing for terminating the display of the pop-up 91 may be set according to the level of importance of the message. For example, the predetermined period of time is set longer as the level of importance of the message is higher.

Next is a more concrete explanation of the display manner of displaying a pop-up. In S3, as shown in FIG. 5B, under a condition where the pop-up display position is set at a location other than display regions for the soft buttons 81, 82 designated as the predetermined display region, the display control section 111 allows the display section 21 to display the message subject to the instruction in the form of a pop-up 91 on the display screen, for example, while giving a transmittance of 0% (non-transmissivity) to the background color of the pop-up 91. By displaying the pop-up 91 in this manner, it can be avoided that the user's visibility and operability of the soft buttons 81, 82 are hindered.

Alternatively, in providing the display of the pop-up 91 in S3, as shown in FIG. 5C, the display control section 111 may provide an animation display, for example, by sliding the pop-up 91 into the display screen 90, for example, from a lower portion of the display screen 90, such as a display region for the soft buttons 82, and transferring the pop-up 91 to the pop-up display position shown in FIG. 5B. As described previously, the type of the animation display is determined by being retrieved from the pop-up display manner storage section 113 according to the level of importance of the message by the display control section 111. With the use of the animation display, even if there is no fixed display region for the message, the user can easily recognize that the pop-up 91 is displayed.

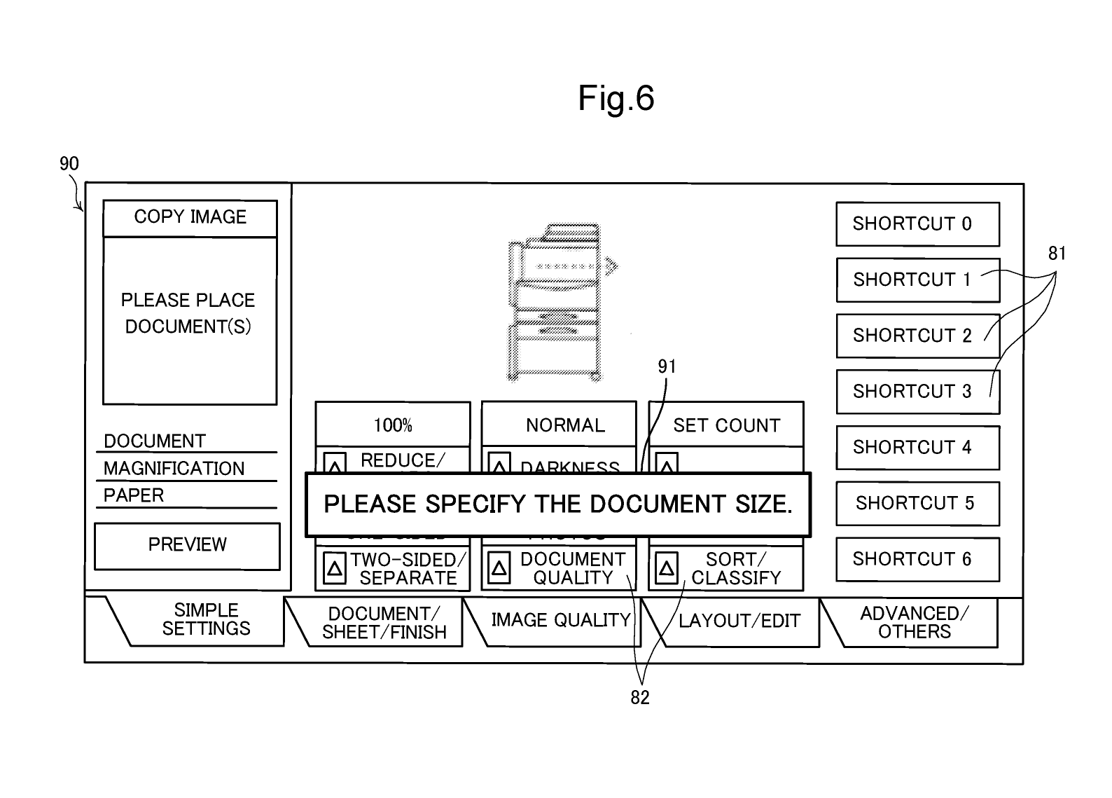

When the level of importance of the message, which in S3 the display control section 111 has received together with the instruction to display the message from the message control section 112, is a predetermined extremely high level of importance (for example, a maximum level of importance “5”), as shown in FIG. 6, the display control section 111 may, only in this case, display the pop-up 91 in the region where the soft buttons 82 are displayed, while giving a transmittance of 0% to the background color of the pop-up 91. If the pop-up 81 is displayed just over the soft buttons 82 in this manner, the user can recognize the pop-up 91 when making a gesture on any soft button 82 and, therefore, the message can be surely delivered to the user.

Even if the pop-up is displayed on the display section 21, the touch panel 22 can accept pressing on any soft button 82 originally displayed at the position where the pop-up is displayed and the control section 110 can execute processing corresponding to the pressed soft button.

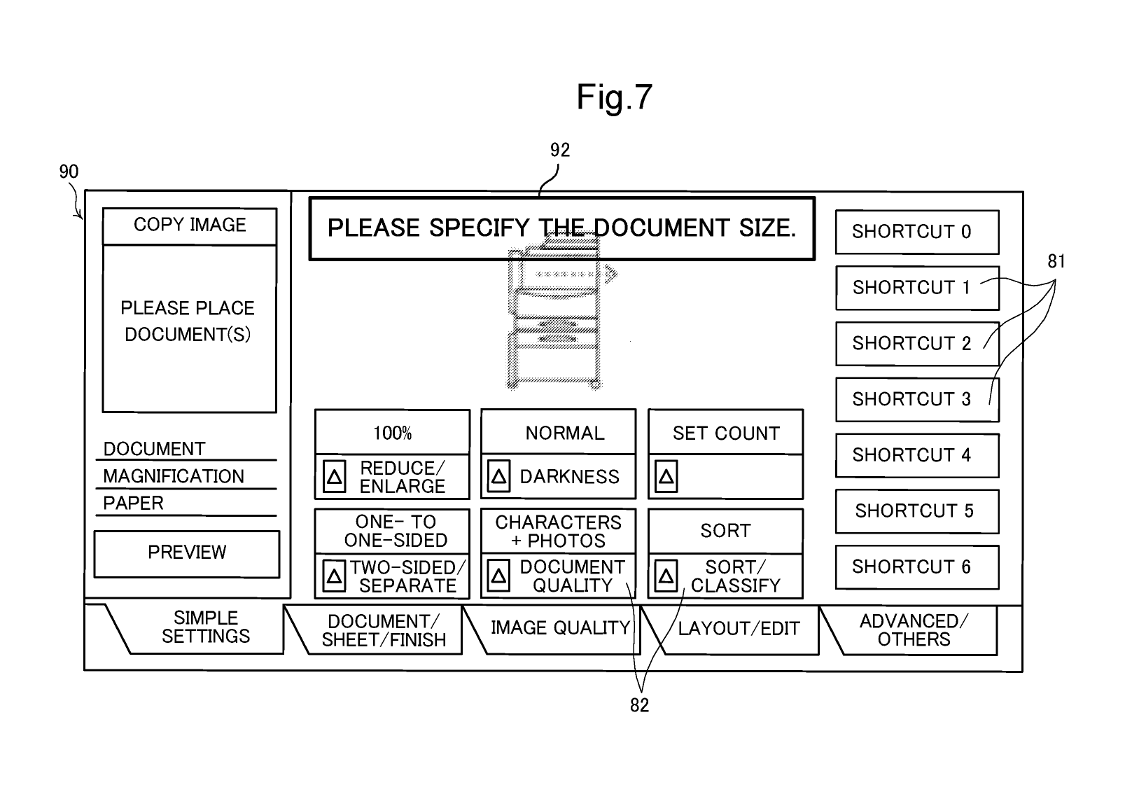

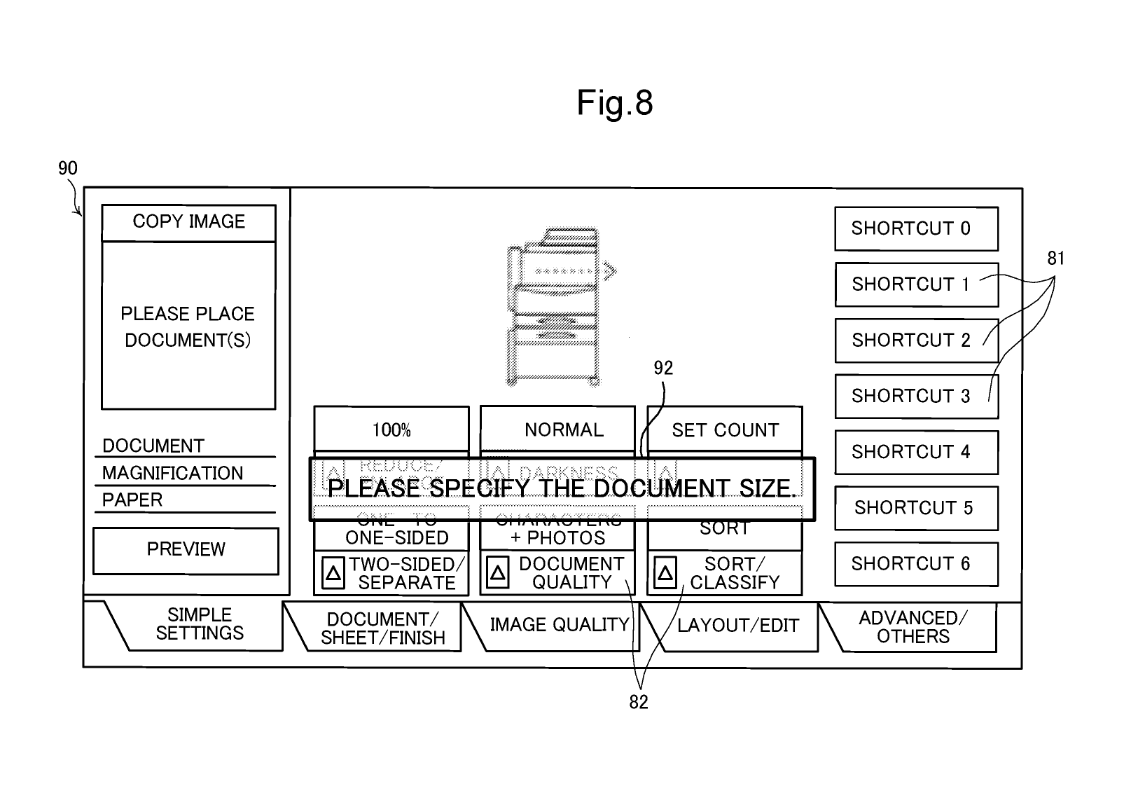

Furthermore, in S3, the display control section 111 may provide display of a pop-up message, for example, at a transmittance predetermined according to the level of importance of the message. The transmittance is stored, in the pop-up display manner storage section 113, for each message according to the level of importance of the message. In providing display of a message in the form of a pop-up, the display control section 111 retrieves the transmittance from the pop-up display manner storage section 113. FIGS. 7 and 8 show exemplary screens where a pop-up 92 is displayed at a transmittance of 50%. FIG. 7 shows a state where the display control section 111 provides display of the pop-up 92 in a region other than the display regions for the soft buttons 81, 82. FIG. 8 shows a state where the display control section 111 provides display of the pop-up 92 in the display region for the soft buttons 82. By giving the pop-up 32 transmissivity in the above manner, the user can view and recognize illustrations or soft buttons originally displayed under the pop-up, so that reduction in visibility and operability can be prevented.

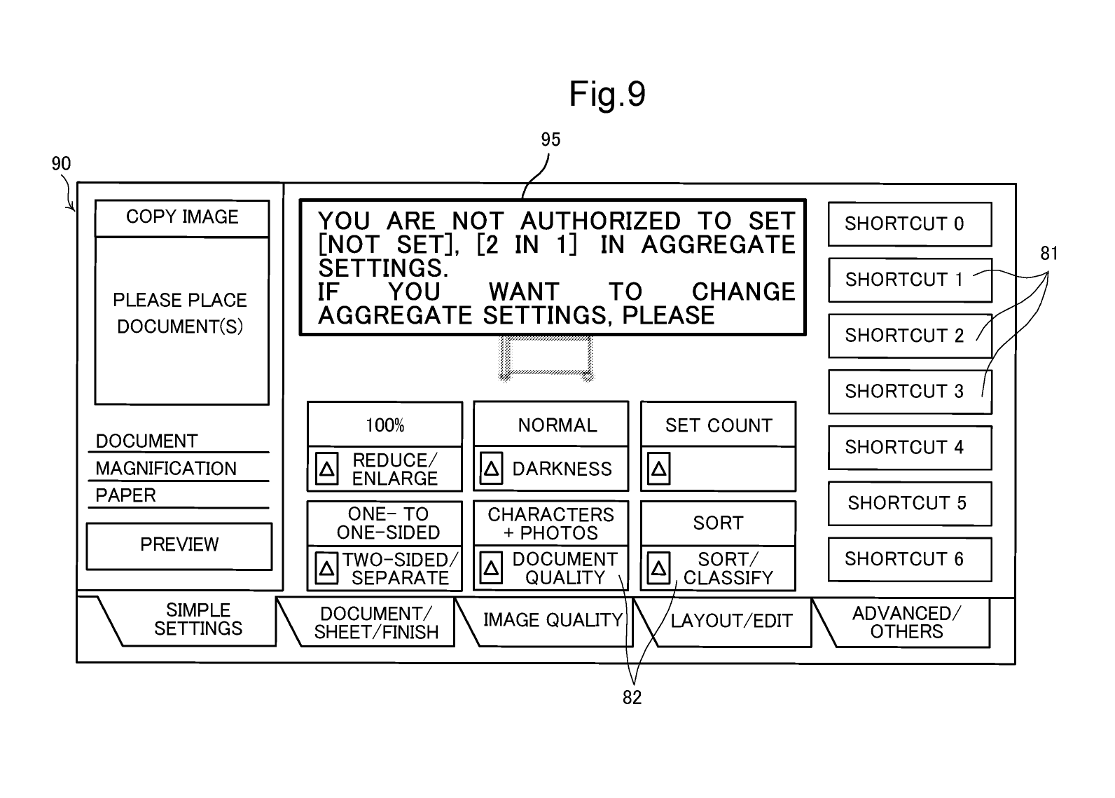

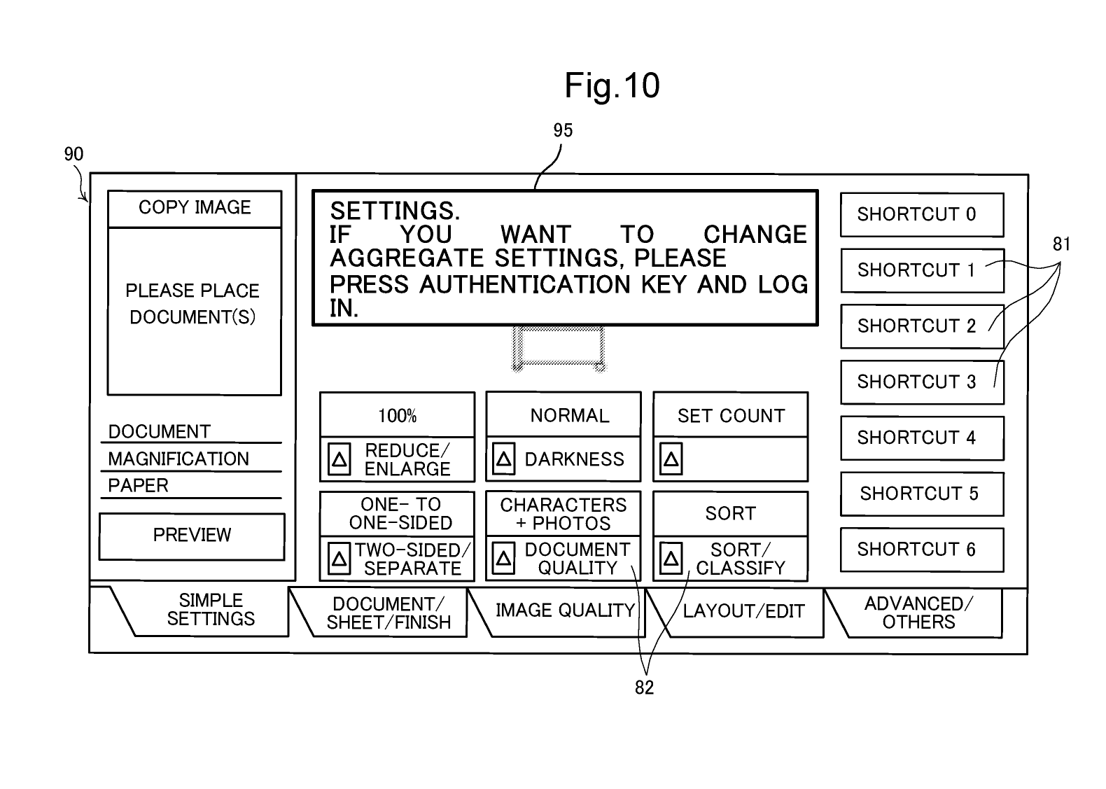

Moreover, for example, in providing a pop-up display of a long message in S3, the display control section 111 may provide an animation display by scrolling up the whole message in lines in a pop-up 95, like a title roll. FIGS. 9 and 10 are views showing how a long message is displayed while being scrolled up in lines in the pop-up 95. For example, in displaying four or more lines of message in a region of the pop-up 95 where at most three lines of message can be displayed, the display control section 111 enables the display of the full message using an animation display. By providing an animation display of a plurality of lines of message in this manner, the contents of the message can be effectively delivered to the user.

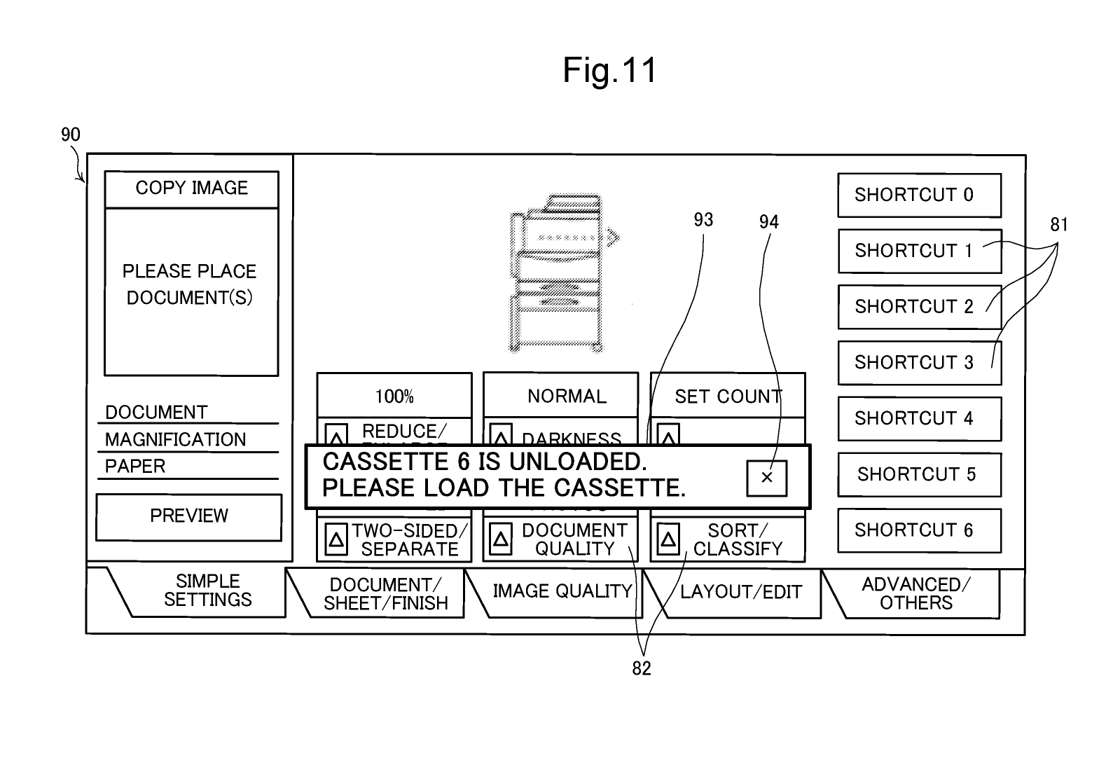

Next, a description will be given of other embodiments of the pop-up display. FIG. 11 shows an exemplary screen where a pop-up 93 containing a close button 94 is displayed. In providing a pop-up display in S3 shown in FIG. 4, the display control section 111 may provide display of the close button 94, in addition to the message being subject to the instruction, in the pop-up 93.

When the touch panel 22 detects a user's touch on the close button 94, the display control section 111 terminates the display of the pop-up 93 even before the passage of the predetermined period of time. Thus, the user can clear the pop-up message after recognizing the message, but must make a gesture of pressing the close button 94 displayed in the pop-up 93 in order to clear the message. Therefore, by clearing the pop-up 93, the user's visibility of the display screen can be increased and the user can surely recognize the message.

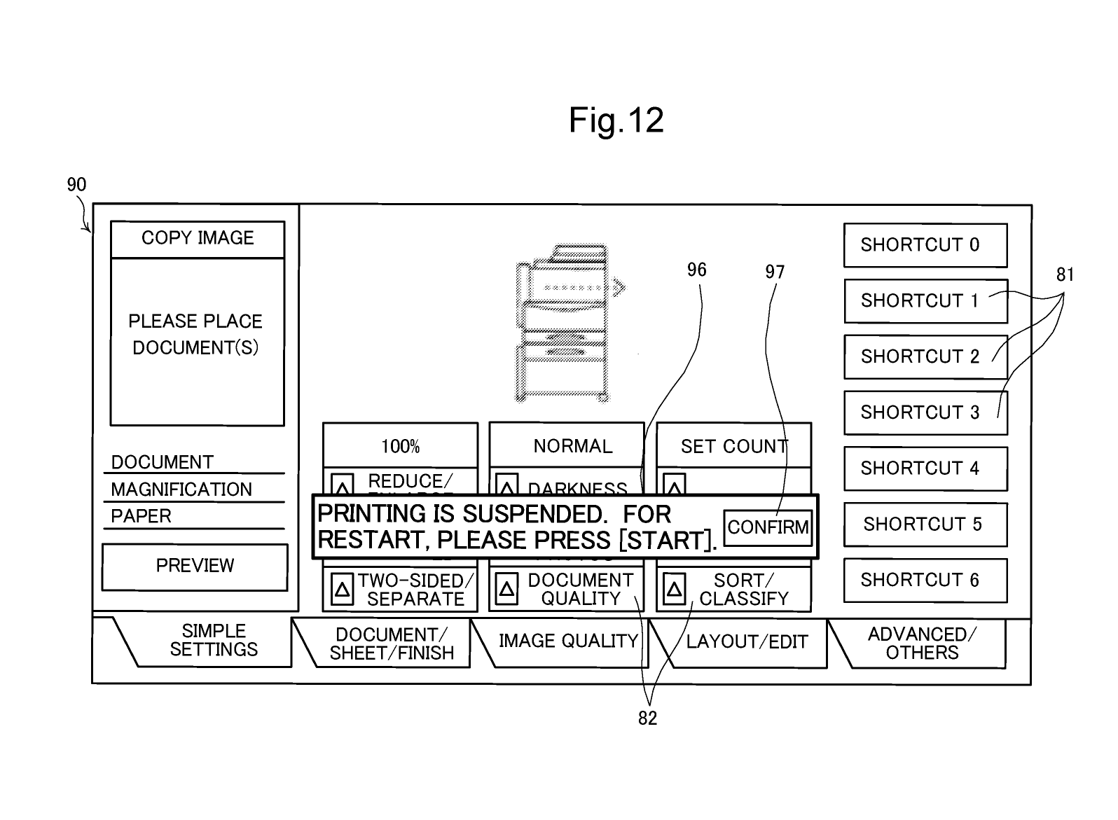

FIG. 12 shows an exemplary screen where a pop-up 96 containing a CONFIRM button 97 is displayed. In providing a pop-up display in S3 shown in FIG. 4, the display control section 111 may provide display of the CONFIRM button 97, in addition to the message being subjected to the instruction, in the pop-up 96.

For example, when during suspension of operation of the image forming apparatus 1 for any reason the user attempts to operate the image forming apparatus 1 through a soft button or a hard button, but the control section 110 determines that the user's operation cannot be accepted, the message control section 112 issues an instruction to the display control section 111 to display the CONFIRM button 97 together with a message. Then, in accordance with this instruction, the display control section 111 provides display of the message and the CONFIRM button 97 in the pop-up 96.

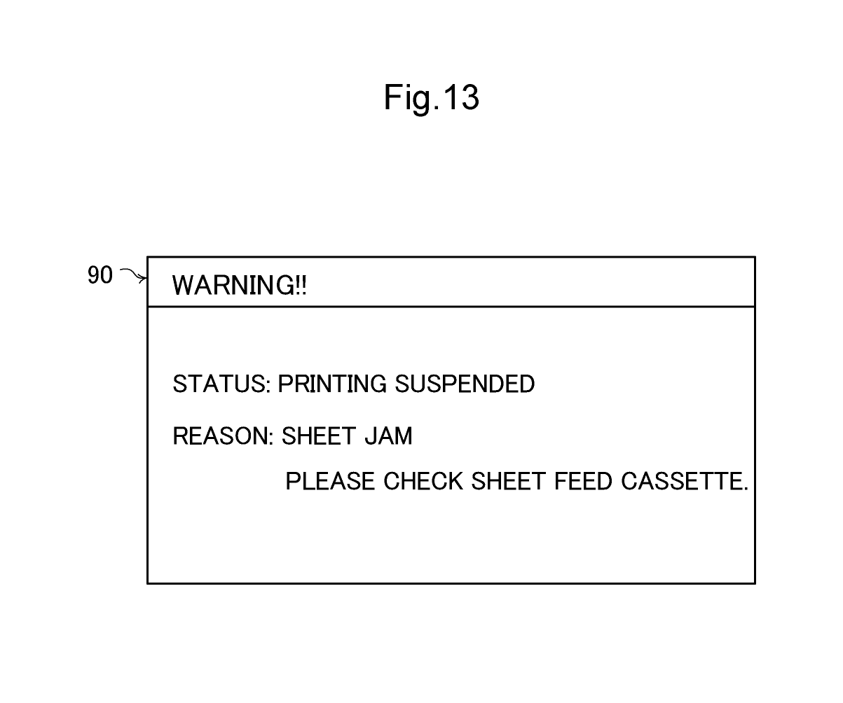

This CONFIRM button 97 is a button for accepting an instruction to display an explanatory screen indicating the status of the image forming apparatus 1. For example, when the touch panel 22 detects a user's touch on the CONFIRM button 97, the touch panel 22 outputs to the display control section 111 an instruction to display an explanatory screen indicating the status of the image forming apparatus 1. In response to this, the display control section 111 terminates the display of the pop-up 96 even before the passage of the predetermined period of time and allows the display section 21 to display an explanatory screen indicating why printing is suspended, as shown as an example in FIG. 13. Thus, the user can immediately know the status of the image forming apparatus 1.

Likewise, in the case where it is desirable to explain to the user a specific operation procedure, the display control section 111 may also provide the display of a CONFIRM button 97 for displaying a screen indicating the operation procedure and, upon detection of a touch on the CONFIRM button by the touch panel 22, allow the display section 21 to display an explanatory screen indicating the operation procedure.

The above explanatory screens are previously stored in the storage section, such as the HDD 92, of the image forming apparatus 1. By in the above manner appropriately providing display of the CONFIRM button 97 which is a button linked to an explanatory screen, the user can immediately switch the display from the display screen where a pop-up is displayed to the explanatory screen to know the status of the image forming apparatus 1. Therefore, user's convenience and operability of the image forming apparatus 1 can be increased.

Here, a description will be given of a general display input device. When a banner is displayed on the general display input device with a large number of items having already been displayed thereon, there arises the problem that the banner makes already displayed important information invisible. Furthermore, when the banner is displayed, it becomes impossible to operate soft buttons being displayed. In addition, the general display input device cannot solve the above problems even if it can immediately respond to a change in status, such as receipt of a mail, during display of a locked screen. Moreover, the operation screen of the general display input device includes a fixed region for displaying a message and, also in this respect, the general display input device has the problem to be solved that previously displayed important information becomes invisible.

In contrast, in the image forming apparatus 1 according to this embodiment, no fixed region for displaying a message is provided on the display screen of the display section 21 and the message is displayed in the form of a pop-up at a pop-up display position of the display screen set at a location other than a predetermined display region of the display screen. Thus, even if there is no fixed region for displaying a message, the display of a pop-up in the above manner enables the user to recognize the message and a status change of the apparatus.

Therefore, since in the image forming apparatus 1 no fixed region for a message is provided on the display screen to be displayed on the display section 21, some information can be always displayed on the entire display screen of the display section 21, which enables effective use of the entire display screen. Furthermore, even if a new message is displayed in the form of a pop-up, the user can surely view important information having already been displayed on the display section 21, such as the soft buttons 81, 82.

Moreover, since the touch panel 22 accepts a user's touch of any soft button 81, 82 on the display screen of the display section 21 even during display of a pop-up thereon, the display of the pop-up 91 does not hinder any user's gesture on the soft button 81, 82. Therefore, the display of the pop-up does not reduce the user's operability of the image forming apparatus 1.

In addition, since a message is displayed in the form of a pop-up at the pop-up display position away from the predetermined display region on the display screen of the display section 21, this also provides the effect that the user becomes more easily aware of the display of a new message or a change in display contents than when the message is displayed in the fixed region.

Furthermore, the message control section 112 issues an instruction to the display control section 111 to display a message to which a level of importance of the contents of the message is added, and, thus, the display control section 111 allows the display section 21 to display a pop-up message so that the pop-up varies in transmittance of the background color, animation, color, and so on according to the level of importance. By giving movement or variety to the pop-up in this manner, the message can be more effectively recognized by the user.

Moreover, since the administrator or the like of the image forming apparatus 1 can arbitrarily make the settings of the pop-up display manner (display position, transmittance, animation, color, and so on) according to the level of importance of the pop-up, the pop-up can be displayed as being effectively adjusted according to characteristics of the user of the image forming apparatus 1.

As seen from the above, it becomes possible to effectively use the display area of the display section 21, make the user intuitively and efficiently aware of a message, and avoid that the operability is hindered owing to a pop-up display of a new message making previously displayed important information invisible.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. A display input device comprising:
a display section capable of displaying characters and images;
a touch panel that is disposed in the display section and accepts input by pressing on a soft button displayed on a display screen of the display section; and
a control unit that includes a processor and performs, when the processor operates in accordance with an operation program, a display control of the display screen to be displayed on the display section and a control for instructing the display section to display a message,
wherein when instructing the display section to display the message while allowing the display section to display the display screen, the control unit provides display of the message in the form of a pop-up at a pop-up display position of the display screen set at a location other than a predetermined display region of the display screen, and
the touch panel accepts the input by pressing on the soft button even while the control unit provides the display of the pop-up.

2. The display input device according to claim 1, wherein the control unit provides the display of the pop-up as an animation display in which the pop-up is transferred from a predetermined position in a display area of the display section to another predetermined position in the display area.

3. The display input device according to claim 1, wherein
the control unit instructs the display of the message to which a level of importance of the message is added,
the control unit further performs a control for storing a transmittance of a background color of the pop-up in association with the level of importance,
the control unit stores the transmittance so that the higher the level of importance, the lower the transmittance of the background color of the pop-up, while the lower the level of importance, the higher the transmittance of the background color of the pop-up, and
the control unit retrieves the transmittance of the pop-up based on the level of importance and provides the display of the pop-up of the message at the pop-up display position using the retrieved transmittance.

4. The display input device according to claim 3, wherein
the control unit further stores a setting that the pop-up display position is located in a display region for the soft button when the level of importance of the message is a predetermined level, and a setting that the pop-up display position is located other than the display region for the soft button when the level of importance of the message is low, and
the control unit retrieves the pop-up display position based on the level of importance and provides the display of the pop-up of the message on the display screen using the retrieved pop-up display position.

5. The display input device according to claim 3, wherein
the control unit further stores a color of the pop-up in association with the level of importance of the message, and
the control unit retrieves the color of the pop-up based on the level of importance and provides the display of the pop-up of the message on the display screen using the retrieved color.

6. The display input device according to claim 3, wherein the level of importance is indicated by a numerical value so that the higher level of importance is indicated by a larger value.

7. The display input device according to claim 1, wherein the control unit terminates the display of the pop-up on the display section after the passage of a predetermined period of time since the start of the display of the pop-up.

8. The display input device according to claim 7, wherein
the control unit provides display of, together with the pop-up, a close button for accepting input of a user's instruction to terminate the display of the pop-up and,
when the touch panel accepts the input by pressing on the close button, the control unit terminates the display of the pop-up even before the passage of the predetermined period of time.

9. The display input device according to claim 1, wherein
the control unit issues an instruction to display, together with the pop-up of the message, a confirm button for accepting an instruction to display detailed information on the message and allows the display section to display the confirm button together with the pop-up associated with the message, and
when the touch panel accepts input by pressing on the confirm button, the control unit allows the display section to display the detailed information on the message.

10. The display input device according to claim 3, wherein contents to be stored in the control unit is arbitrarily settable.

11. An image forming apparatus comprising:
the display input device according to claim 1; and
an image forming section that forms an image on a recording medium.
